(19) United States
(12) Patent Application Publication
(10) Pub. No.: US 2020/0283601 A1
(43) Pub. Date: Sep. 10, 2020

(54) BIODEGRADABLE HYDROGEL

(71) Applicants: Giacomo GUERRINI, Follonica (GR) (IT); UNIVERSITA' DEGLI STUDI DI PADOVA, Padova (IT)

(72) Inventors: Giacomo GUERRINI, Follonica (GR) (IT); Michele MAGGINI, Selvazzano Dentro (PD) (IT); Silvia GROSS, Padova (IT); Valerio CAUSIN, Venezia (IT)

(73) Assignees: UNIVERSITA' DEGLI STUDI DI PADOVA, Padova (IT); Giacomo GUERRINI, Follonica (GR) (IT)

(21) Appl. No.: 16/648,930

(22) PCT Filed: Sep. 21, 2018
(86) PCT No.: PCT/EP2018/075691

§ 371 Date: Mar. 19, 2020

(30) Foreign Application Priority Data
Sep. 21, 2017 (IT) 102017000105979

(51) Int. Cl. C08L 1/28; C08J 3/075; C08J 3/24

(52) U.S. Cl. CPC C08L 1/286; C08J 2301/28; C08J 3/24; C08J 3/075

(57) ABSTRACT

A hydrogel comprises one or more hydrosoluble polysaccharides which are cross-linked by cross-linking agents, wherein the cross-linking agents form covalent bonds with the polysaccharides, and wherein the cross-linking agents comprises humic and/or fulvic acids.

### TECHNICAL FIELD

The present invention refers to the field of hydrogels, in particular, to a biodegradable hydrogels based on hydrosoluble polysaccharides and humic and/or fulvic acids.

### Background Art

Within the wide family of gels, hydrogels are particularly important for their affinity with water, thus posing themselves as materials with a high potential in diverse fields such as drug release or tissue regeneration. Therefore, a very rich literature exists on these materials, in which, though, several issues still remain under investigated. The relative complexity of these hydrogels, whose synthesis generally requires the polymerisation of suitable monomers, limited the applications of the most performing hydrogels to the biomedical field, where a high cost is still acceptable. On the other hand, for mass market applications such as absorbents for diapers, less sophisticated materials are employed, which however are not biodegradable and cause severe environmental issues.

A hydrogel is a polymeric network formed by a 3D-framework of physically or chemically cross-linked polymer chains which can absorb and retain significant quantities of water for which it has a high chemical affinity. In particular, a hydrogel may absorb an amount of water equal to several times the weight of the dry hydrogel, typically tens of times and up to the 100 or 200 times its own weight.

The polymeric framework shall therefore be able to modify its steric configuration, in order to allow an appropriate swelling of the hydrogel, and, at the same time, shall be insoluble in water and very hydrophilic so as to allow water absorption without dissolving in it.

To this end, the polymeric framework of a hydrogel shall have a proper cross-linking degree, which allows a great mobility of the polymer chains without, however, degrading its 3D structure and dissolving in water. This is obtained when the cross-linking degree of the polymer framework is comprised in a range of values which could be rather narrow. Actually, when the cross-linking degree of the polymer framework is too low, the material would easily dissolve in water and when the cross-linking degree of the polymer framework is too high, the material would be too rigid for absorbing any significant amount of water.

Hydrogels are characterised by a strong viscoelastic behaviour due to the co-presence of two phases: a solid matrix generated by the cross-linking of the polymer chains and the liquid absorbed in it. When subjected to rheology analysis (for instance using an shear rheometer) they show a complex shear modulus having a viscous component (also known as “loss modulus”, generally due to the liquid component) and an elastic component (also known as “storage modulus”, generally due to the solid matrix). A hydrogel is characterised by a storage modulus value higher than its loss modulus. Usually, the hydrogels proposed for drug release in biomedical applications are characterised by a backbone based on acrylic polymers, variably functionalised with receptors which trigger the interaction with the target tissues and functional groups or allow for the loading with an active principle, with biocides, with agents favouring the growth of the desired cells, etc. However, the main drawback of acrylic polymers is that they are not readily degradable, and, when disposed as biomedical devices or when used in specific agricultural applications, they may alter the hydrodynamic equilibrium of the soil if released in the environment.

CN105399896 (A) describes the preparation of a composite gel material. Attapulgite is subjected to water washing and acid washing, and is modified through a sodium chloride solution, hexadecyltrimethylammonium bromide, and a humic acid to prepare humic-acid-modified attapulgite. The humic-acid-modified attapulgite and acrylamide hydrogel are compounded to prepare the product of the composite gel material.

CN 102477304 discloses a liquid film formed by a polysaccharide cross-linked with clay modified with humic acid which can be sprayed onto the soil so as to form, when dehydrated, a biodegradable mulching film. This material is obtained by mixing in water, at low temperatures, the polysaccharide and the humic modified clay in presence of FeSO₄ so that the polysaccharide and the humic modified clay are joined together by ionic bonds. The material when dried results in a solid, the consistency and the properties thereof being not comparable to the one of a hydrogel.

U.S. Pat. No. 8,658,147 B2 describes a method for the preparation of a polymer hydrogel, from a hydrophilic polymer optionally in combination with a second hydrophilic polymer and a polycarboxylic acid as cross-linking agent.

However, the capacity of this hydrogel to retain and/or gradually release possible compounds dissolved in the water absorbed in the hydrogel is quite limited.

The problem underlying the present invention is that of providing a biodegradable hydrogel and a method for the preparation thereof, which can solve, at least in part, one or more drawbacks of the hydrogel according to the cited prior art.

In particular, it is an aim of the invention to provide a hydrogel having a relevant capacity of retaining or gradually release a wide variety of compounds dissolved in water.

Another aim is to provide a hydrogel which is substantially formed by natural compounds and which is obtainable at low costs.

An additional aim of the invention is to provide a hydrogel which is particularly suitable for use in the field of agriculture or related environmental applications.

### SUMMARY OF THE INVENTION

In a first aspect thereof, the present invention is directed to a hydrogel comprising one or more hydrosoluble polysaccharides which are cross-linked by cross-linking agents, wherein the cross-linking agents form covalent bonds with the polysaccharides, and wherein the cross-linking agents comprise humic and/or fulvic acids.

In a second aspect thereof, the present invention is directed to a method for preparing a hydrogel comprising the steps of cross-linking one or more hydrosoluble polysaccharides by forming covalent bonds with a cross-linking agent which comprises humic and/or fulvic acids.

Thanks to the above features, it is provided a hydrogel in which clay and humic and/or fulvic acids are part of the polymer framework, so that their high capacity of interacting with a large variety of compounds may be effectively exploited in the hydrogel.

In addition, the humic and fulvic acids have been incorporated in a 3D polymeric framework as cross-linkers of polysaccharides, or at least as part of the cross-linkers, and this is also surprising in view of the great inhomogeneity and complexity of the structure of humic and fulvic acids, which, indeed, makes very difficult any forecast about their possible behaviour in a reaction with other compounds.

The hydrogel of the invention is biocompatible and also shows soft self-healing properties in presence of complexing cations (e.g. Ca²⁺), the hydrogel being capable to biodegrade by releasing into the environment substances recognized as the basis of soil fertility.

Indeed, no toxic substances are released from the degradation of the hydrogel. The hydrogel is composed of natural organic and mineral matrices present in the soil (natural polymers, humic substances, possibly metal and alkaline ions) and its synthesis is inspired by the natural processes that generate the soil structure and its aggregates.

In addition, the hydrogel of the invention may also release, gradually or after its degradation, substances absorbed by the humic/fulvic acids through the water.

In one preferred embodiment of the invention, the humic/fulvic acids are, at least in part complexed to clays, so as to form an organo-mineral complex.

Surprisingly, it has been found that humic and fulvic acids enhance the solubility of clay in water, mediating the interactions between the polysaccharides and the clay, making possible an easy dispersion of the clay in the hydrogel matrix.

In this way, clays are incorporated in the hydrogel, also as part of the 3-D framework, so as to further enhance the capacity of interaction with water and with the compounds dissolved or suspended in it. In addition clay is a common natural material.

Clays are characterized by a high degree of isomorphic substitution in their crystalline structure (Attapulgite, Montmorillonite, vermiculite, etc.) and consequently have typically a strong negative charge. Negative charged clay, when mixed with humic and fulvic acids in appropriate conditions, form the above mentioned organo-mineral complexes, which bear different functional groups (hydroxyls, phenols, carboxylic acids).

The inventors has advantageously verified that these functional groups may be effectively used to link by covalent bonds the organo-mineral complex to natural and highly hydrophilic polymers, in particular hydrosoluble polysaccharides (such as pectin, natural gums, starch, modified cellulose, etc.), so as to cross-link the polymers up to form a 3D framework, which may show the typical properties of a hydrogel, both in terms of capacity of water absorption and in terms of viscoelastic behaviour.

The hydrogel can be prepared with many different molar ratios between its components (humic/fulvic acids vs. clay; clay vs. polysaccharides), so as to obtain hydrogels with different properties, which can be advantageously chosen as a function of the intended final application of the hydrogel.

The hydrogel preparation method is simple, safe, green and cost effective, it uses water as dispersing medium, it does not require any special equipment and is easily applicable for many industrial applications.

In another preferred embodiment of the invention, the cross-linking agents are constituted by humic and/or fulvic acids, alone or complexed to clay, which are directly bonded to the hydrosoluble polysaccharides with covalent bonds.

In this case, the covalent bonds are the result of esterification reactions between the hydroxyl groups and the carboxylic groups which are abundant both in humic and fulvic acids and in hydrophilic polysaccharides.

In a further preferred embodiment of the invention, polysaccharides are cross-linked by means of the organo-mineral complexes along with an auxiliary cross-linking agent, preferably a polycarboxylic acid, which may have esterification reactions with hydroxyl groups of both polysaccharides and humic/fulvic acids.

In this case, any polycarboxylic acid may react with the organo-mineral complex and the polysaccharide or may react with two polysaccharide chains. In both cases, cross-linking of the polysaccharides is obtained.

The hydrogel of the invention finds application in the field of agriculture or in other kinds of industry and human necessities, as better explained below.

In a further aspect, it is provided a biodegradable polymer-clay composite, comprising one or more hydrosoluble polysaccharides which are cross-linked by cross-linking agents, wherein the cross-linking agents form covalent bonds with the polysaccharides, and wherein the cross-linking agents comprises an organo-mineral complex formed by humic and/or fulvic acids complexed to clay, which is in the form of a dry solid.

This composite material is analogous to the hydrogel of the invention, but it has a much higher cross-linking degree, so that it may not be considered a hydrogel. In particular, this material has no relevant capacity of absorbing water (it is substantially not swellable), while it has a higher elastic modulus. The composite material, in particular when containing a high fraction of clay, show unexpected fire resistance properties and may be advantageously used as fire retardant material, for instance as coating for panels in the building construction field.

### DETAILED DESCRIPTION OF THE INVENTION

According to the present invention, clays includes phyllosilicates such as smectites (Montmorillonite, Attapulgite) and vermiculite. According to the invention clays are preferably negative charged and swellable clays.

Clays are made of tetrahedral and/or octahedral layers, whereas Attapulgite has only tetrahedral layers. These minerals often have isomorphic substitutions and the result of this substitution is that the crystal assumes a permanent negative charge. Allophane, an amorphous clay, is also highly negatively charged (sometimes even positive).

Clays have considerable swelling properties, exchange surface area and porosity.

TABLE 1
Main properties of negative charged clays

| | | | Internal |
|---|---|---|---|
| | Layer | Swelling | specific |
| | charge | degree | surface |
| Clay | mV | % | m²/g |
| Montmorillonites | −80/−150 | 250 | 600-800 |
| Vermiculites | −100/−200 | 50 | 600-800 |
| Attapulgite | n.a. | n.a. | >160 |
| Allophane/imogolite | +20/−150 | n.a. | 100-1000 |

As previously said, the humic/fulvic acids, due to their physical-chemical nature, combine naturally with clays, forming an organo-mineral complex, which can link to the polysaccharide matrix, directly, or through an auxiliary cross-linking agent, such as a polycarboxylic acid.

The different functional groups of humic/fulvic acids, in fact, can give rise to esterification reaction with the polycarboxylic acid and/or with the polysaccharide matrix. It has been also observed that the combination of humic/fulvic acids and clays enhances the solubility of the clays; this feature contributes to an efficient linking to the polymer. Such process makes it possible to create an organo-mineral hydrogel or composite following a sustainable, easy and cheap route.

Humic and fulvic acids are one of the best natural chelating products available in the natural environment. The high cations exchange capacity (CEC) of 100-400 meq/100 g of humic acids, endows the hydrogel with the capacity to transport elements and molecules. Humic and fulvic acids are rather complex mixtures of many different acids containing a variable quantity of carboxyl, hydroxyl and phenolate groups.

Fulvic and humic acids have some structure similarities; they differ for the average molecular weight and for the average ratios of functional groups, as summarised in the following table. Humic and fulvic acids are beneficial and natural constituents of soil and, if dispersed in the environment, they are neither pollutants nor contaminants.

TABLE 2
Exemplary acidity values, COOH and phenolic OH contents
average and molecular weights in humic and fulvic acids

| | | | | Average |
|---|---|---|---|---|
| | Total | | Phenolic | molecular |
| | acidity | COOH | OH | weight |
| | (meq/g) | (mol/kg) | (mol/kg) | (uma) |
| Humic acids | 5-6 | 0.36 | 0.31 | 50000 |
| Fulvic acids | 10-15 | 0.82 | 0.30 | 5000 |

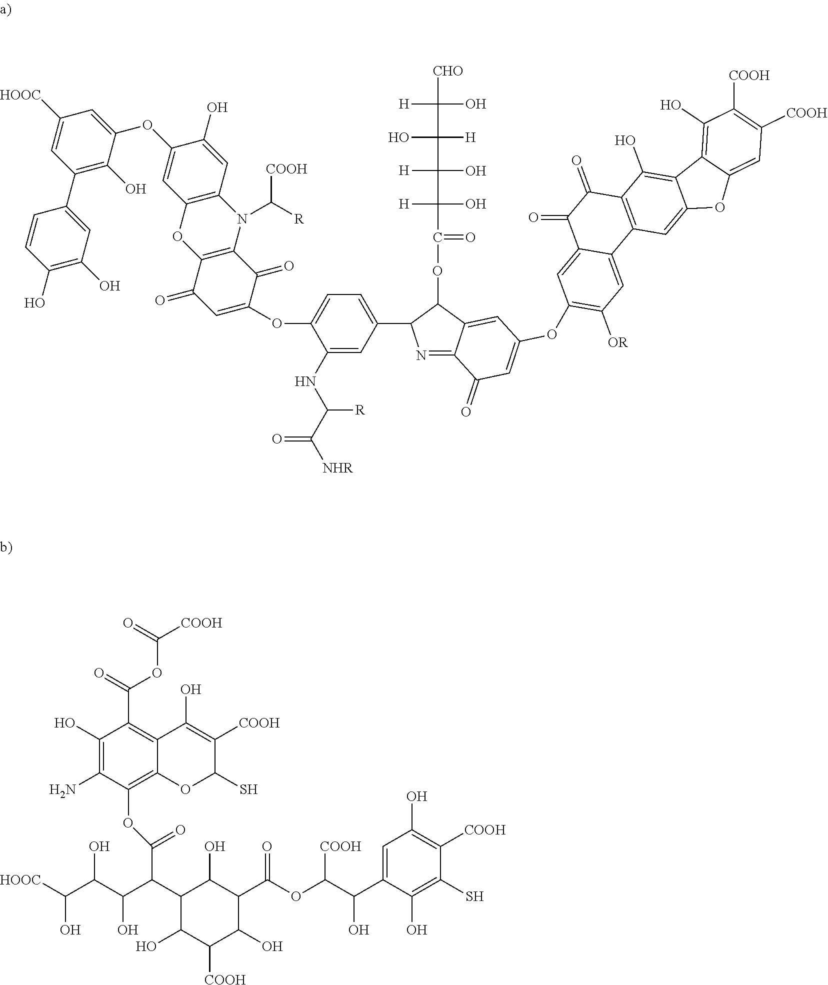

Examples of typical structures of a) a humic acid and b) a fulvic acid

According to the invention, polysaccharides are highly hydrophilic substituted polymers, example polysaccharides include substituted celluloses, dextrans and substituted dextrans, starches and substituted starches, glycosaminoglycans, pectins, chitosan, natural gums and alginates. The “polysaccharide” can be:
a) ionic polymers with acidic or basic functional groups on the backbone chain (acidic groups as a carboxyl, sulfate, sulfonate, phosphate or phosphonate group; basic groups, such as an amino, substituted amino or guanidyl group). Ionic polymers, when in aqueous solution, become an anionic polymer or a cation polymer depending on the pH value. A preferred ionic polymer in this patent is carboxymethylcellulose.
b) non-ionic polymers that do not include ionisable functional groups (acidic or basic) along the backbone chain, will be uncharged in aqueous solution despite of the pH value. The preferred nonionic polymer is corn or potato starch.

The hydrogel of the invention might comprise a mixture of different polysaccharides (ionic and nonionic), to improve its own properties.

Polycarboxylic acid refers to an organic acid having two or more carboxylic acid functional groups, such as dicarboxylic acids, tricarboxylic acids and tetracarboxylic acids, and also includes the anhydride forms of such organic acids. A particularly preferred polycarboxylic acid is citric acid (CA) because non-toxic and available on the market at low cost.

In the hydrogel of the invention, humic/fulvic acids interact strongly with clay particles to form organo-mineral complexes by van der Waals interactions, hydrogen bonds and through ionic bonds by positively charged ions normally present in the clay (Fe³⁺, Na⁺, Ca²⁺, etc). These cations have different complexation powers, (Fe³⁺, Na^{t}, Ca²⁺), the favorite ion being Ca²⁺ because often naturally present in clay minerals. It is however possible to modulate the stability of the complexes also by the use of different cations or mixture of them.

Organo-mineral complexes, bearing several functional groups, are available for a wide number of interactions and additionally offer sites for cross-linking. Due to the variability of the raw material used, with the help of the laboratory analysis, characterization and empirical evidences, it is possible to optimise the complexation with clay defining the right molar ratio between the organic and the inorganic fraction.

The pH influences the complexation, a value from 4 to 6 generally ensures a good complexation. The average size of the complex can be monitored by DLS analysis and tuned by pH value and the mixing procedure between organic and mineral matter. These organic-mineral complexes are the constituent of structure and aggregate in the soil; their dispersion in the environment is completely safe.

According to the invention, the organo-mineral complex is a composite mixture of clays and humic/fulvic acids, wherein at least a fraction of the humic/fulvic acids is complexed to at least a fraction of the clays.

At least a fraction of humic/fulvic acids, due to their carboxylic groups present in the acid structure, participates to the esterification reaction, forming covalent bonds with the polysaccharide matrix, also when an auxiliary cross-linking element, such as a polycarboxylic acid, is used.

Humic/fulvic acids in the complex organo-mineral mixture may also play the role of molecular spacers among carbohydrate polymers, thus hampering their crosslinking. This conveniently contributes to enhance the ability of the polymer network to expand and increase its absorption and swelling characteristics.

Humic/fulvic acids can be extracted from pot-soil, by immersing completely the pot soil in a basic water solution (preferably a 0.1 M aqueous KOH for 24 hours). After the immersion, the liquid phase is separated from the solid residue by centrifugation. The resulting liquid phase is a dilute mixture of fulvic and humic acids. In order to separate humic and fulvic acids, the pH is set to 2, then by centrifugation the humic acids are easily separated from fulvic acids because humic acids are insoluble in acidic solution, opposite to the fulvic acids which are soluble.

Clays are preferably prepared in colloidal form, starting from Ca²⁺ Montmorillonite or from the other above-mentioned clay minerals which are suspended in warm water by stirring and sonication, then centrifuged to separate the macroscopic fraction. The resulting colloidal suspension should be stable and well swollen.

Preferably, the organo-mineral complexes are formed by mixing the solution of humic and fulvic acids with the colloidal clay suspension. The humic/fulvic solution confers a higher solubility and lower viscosity to the colloidal clay suspension. Cations as Ca²⁺ shall be present, in solution, in small quantities just to allow ionic bonding between organic and mineral matter; the clay powder usually contains sufficient cations to ensure a quick complexation.

The weight ratio [WR] between the two components of the organo-mineral complex can vary depending of the average molecular weight and percentage of active functional groups of the organic components.

It has been pointed out that, to promote the formation of a hydrogel, the weight ratio between humic/fulvic acids:clay can vary from 0.05 w/w to 2 w/w, more preferably from 0.05 w/w to 0.7 w/w.

In cases where the humic acid fraction is high, if compared to the clay, a major fraction of the humic/fulvic acids will be non-complexed to clays, and will take part to the cross-linking reaction becoming a bridging structure between the polysaccharide chains and providing to the composite a much stiffer structure with tighter pores.

The weight ratio between humic/fulvic acids and polymer can vary from 0.02% w/w to 1 w/w, more preferably from 0.05 w/w to 0.7 w/w.

The hydrosoluble polysaccharide is contacted with the organo-mineral complex preferably in form of a polymeric gel. Preferably, the desired mix of polysaccharides powder is slowly and carefully added to warm distilled water under mechanical stirring, to ensure the right and complete solubilisation and homogenisation, the preferable dilution in distilled water is 1:40 w/w (g dried polymer powder:g water). The solution of organo-mineral complexes, the polymeric gel and, when present, the auxiliary cross-linking element, are mixed according to the molar ratios chosen between organic and inorganic fraction in order to reach the targeted properties (swelling degree, rheological properties, consistency); in fact, by modifying cross-linking degree and clay percentage, it is possible to obtain hydrogels different characteristics. The pH value and the dilution are preferably well tuned with the aim of facilitating the cross-linking reaction. A good homogenisation of the mixture is also requested for an effective hydrogel synthesis.

The weight ratios between clay and hydrosoluble polysaccharides may vary from 1 wt % of clay and 99 wt % of polymer to 95 wt % of clay and 5 wt % of polymer based on the total weight of clays and hydrophilic polymers.

The cross-linking reaction of the polysaccharides chains, performed by the organo-mineral complex or by the polycarboxylic acid, is a double esterification.

The pH value influences the yield of the cross-linking reaction. pH values between 4 and 6 are preferred.

This reaction is preferably carried out at a temperature from about 80° C. to about 150° C. and preferably in dry system, without presence of water. Mixture of polysaccharides and organo-mineral complexes (optionally with polycarboxylic acids) are therefore conveniently dehydrated before heating.

The cross-linking reaction can be also carried out in concentrated system (wt ratio water/total organo-mineral components from 1/1 to 10/1), maintaining it at elevated temperature (90-100° C.) and pH lower than 4 (for instance 2) for a period of time (from 2 to 24 hrs) necessary to complete the targeted reaction.

Preferably, when the cross-linking agent is due to the humic and or fulvic acid alone or complexed with clay, the reaction temperature is higher than 100° C. The extent of the cross-linking reaction is crucial to obtain the hydrogel of the invention. A high cross-linking degree will produce a non swellable dry composite.

The degree of the cross-linking may be adjusted by varying the concentration of the reactants and the reactions parameters (temperature, time, pH, presence of water).

In the embodiment wherein an auxiliary cross-linking element is used, the preferred concentration of such auxiliary cross-linking element preferably varies from 0.5%₀ to 3% (ratio between the weight of auxiliary cross-linking element and the total weight of polysaccharide and humic/fulvic acids).

For the synthesis of dry composite (not swellable), usually the concentration of cross-linkers shall be higher and the cross-linking reaction must proceed to higher degree with respect to that needed for the synthesis of the hydrogel. A non swellable solid is obtainable by using humic and or fulvic acids as cross-linkers and high temperature reaction (more than 120° C.). For instance, in the experimental conditions described in the Example 2, by using a concentration of citric acid 5-10 times higher with respect to the concentration described in the example and at a reaction temperature of 140° C., a non swellable solid is obtained.

The swelling speed and swelling degree of the hydrogel of the invention can be enhanced by several well-known drying strategies capable to produce a higher porosity and create interconnections between the pores.

Usable drying methodologies of hydrated hydrogel are:

i) phase inversion, by immersing the swollen hydrogel in a non-solvent for the composite such as acetone and ethanol,

ii) air drying, preferably under vacuum,

iii) freeze drying at −20° C. and dehydration by a non polar solvent such as acetone,

iv) Oven drying at 35-40° C.

The above methods can be used alone or in combination thereof.

The hydrogel of the invention has a swelling degree, defined as the ratio between the water absorbed the hydrogel and the dry hydrogel, which is higher than 0.5.

By properly modifying the composition of the hydrogel and the reaction parameters, the swelling degree of the hydrogel may be conveniently adjusted in view of the intended use of the hydrogel.

For instance, in a first embodiment, it is preferred that a hydrogel for use as seed coating has a swelling degree (after 24 h immersion in water) of at least 10, more preferably between 10 and 70. In this case the hydrogel is requested to retain a relevant amount of water, necessary to the germination of the seed, and sufficiently soft as to allow sprouting and the radicle growing.

In another embodiment, it is preferred that a hydrogel for use as coating of fertiliser granules may have a lower swelling degree (after 24 h immersion in water), for instance between 0.5 and 10. In this case the hydrogel is requested to be more resistant, to degrade in longer time, and to release gradually the substances of the fertiliser.

The above examples show as the hydrogel of the invention can advantageously be used in agriculture as seed coating (to facilitate germination in case of semiarid conditions or surface seeding), or as hydro-mineral fertiliser.

The hydrogel of the invention can also be advantageously used as:
adsorbent material for manufacturing biodegradable diapers, exploiting as much as possible the high water absorption capacity,
carrier of molecules or ions of interest (for instance drugs, pesticides, etc.), which can be conveniently adsorbed and then gradually released by the organo-mineral complex, or
adsorbent material for environmentally dangerous molecule or ions, which can be definitely retained by the organo-mineral complex.

### BRIEF DESCRIPTION OF THE FIGURES

FIG. 1—DLS (Dynamic Light Scattering) particle size analysis of a generic colloidal clay suspension A (Ca-montmorillonite), which can be used for the preparation of a hydrogel according to the invention.

FIG. 2—DLS particle size analysis of a colloidal clay suspension A (Ca-montmorillonite) mixed with humic acids, in a further step of the preparation of a hydrogel according to the invention.

FIG. 3—Particle size analysis of colloidal clay suspension A (Ca-montmorillonite) mixed with humic acids with the subsequent addition of a complexing agent such as Al3+.

FIG. 4—ATR (Attenuated Total Reflection) spectrum of a hydrogel of the invention having a weight ratio between polysaccharides and clay of 80:20.

FIGS. 5a to 5d—Pictures taken at subsequent times showing the unfolding and swelling of the hydrogel of the invention when immersed in water at room temperature.

FIG. 6—ATR spectrum of a mixture of polysaccharide and humic acids after the esterification reaction.

FIG. 7—representative diagram of the hydrogel of the invention according to one embodiment, showing the basic components and interactions among them.

### EXPERIMENTAL SECTION

### Example 1

Preparation of a cross-linked organic-mineral polymer composite hydrogel (weight ratio polysaccharide/clay: 80/20, with addition of citric acid as auxiliary cross-linking element)

Chemical Solutions Employed, Description:

[UM]. Humic acids solution (average molecular weight 50000 uma): 1 ml solution=0.065 g humic acids, concentration 1.28 10⁻⁶ M. Extracted from common pot-soil. pH adjusted to 7 with KOH and HCl solutions.

[OM]. Suspension of organo-mineral complexes=20 ml solution [UM]+2 g Ca-Montmorillonite powder (common montmorillonite for enological uses). The clay is dispersed in [UM] with magnetic stirring (t 30′), and sonication (30′). The pH is adjusted to 9 with a KOH solution.

[CMA]. Carboxymethyl cellulose (CMC)/Corn starch solution: 40 ml H₂O, +0.6 g CMC sodium salt, +0.3 g of waxy corn starch (amylopectin). Solubilised at T=90° C. using a magnetic stirrer to facilitate the starch gelatinisation. pH adjusted to 9 using a KOH solution.

[CA]. Citric acid solution: 0.525 g granular citric acid (for common enological uses) in 50 ml distilled water, concentration 0.05 M.

Synthesis Description:

1. Mix 1.07 ml of [OM] suspension with 17.8 ml [CMA] solution, to obtain an 80/20 w/w CMA/clay suspension (0.4 g polysaccharide, 0.1 g clay)

2. Thoroughly homogenise with magnetic stirring at T 90° C.

3. Add 0.4 ml of 0.05 M citric acid solution [CA]

4. Adjust pH to 5.5 with HCl solution

5. Homogenise the mixture for 30′ at 90° C. with magnetic stirring

6. Dehydrate sample at T=50° C.

7. Cook in oven at 120° C. for 6 hours

8. Swelling: Hydration of the cooked sample with distilled water at room temperature

9. Dehydrate sample in acetone bath and re-hydrate in distilled water for two times. The measured swelling degree (swollen weight−dry weight)/(dry weight) is 74. Additional dehydration cycles increase the degree of swelling.

### Example 2

Preparation of a Cross-Linked Organic-Mineral Polymer Composite Hydrogel (Weight Ratio Polysaccharide/Clay: 60/40, with Addition of Citric Acid as Auxiliary Cross-Linking Element)

Chemical Solutions Employed, Description:

[UM]. Humic acids solution (average molecular weight 50000 uma): 1 ml solution=0.065 g humic acids, concentration 1.28 10⁻⁶ M. Extracted from common pot-soil. pH corrected to 7 with KOH and HCl solutions.

[OM]. Suspension of organo-mineral complexes=3.3 ml solution [UM]+0.66 g Ca-Montmorillonite powder (common montmorillonite for enological uses)+15 ml distilled H2O. The clay is dispersed in humic acids with magnetic stirring (t 30′), and sonication (30′). The pH is adjusted to 9 with a KOH solution.

[CMC]. Carboxymethyl cellulose (CMC) solution: 40 ml H₂O, +1 g CMC sodium salt, solubilised at T=50° C. with magnetic stirring. pH adjusted to 9 using a KOH solution.

[CA]. Citric acid solution: 0.525 g granular citric acid (for common enological uses) in 50 ml distilled water, concentration 0.05 M.

Synthesis Description:

1. Mix the [OM] suspension and [CMC] solution to obtain a 60/40 w/w CMC/clay (1 g polysaccharide, 0.66 g clay).

2. Thoroughly homogenise with magnetic stirring (t 30′)

3. Add 2 ml 0.05 M citric acid [CA]

4. Adjust pH to 5.5 with HCl solution

5. Homogenise solution for 30′ with magnetic stirring T 25° C.

6. Dehydrate sample at T=50° C.

7. Cook in oven at 136° C. for 6 hours

8. Swelling: hydration of the cooked sample with distilled water at room temperature

9. Dehydrate sample in acetone bath and re-hydrate in distilled water for two times. The measured swelling degree (swollen weight−dry weight)/(dry weight) is 48. Additional dehydration cycles increase the degree of swelling.

### Example 3

Preparation of a cross-linked organic-mineral polymer composite hydrogel with approximate composition: 71.4% montmorillonite clay, 21.4% natural polymer, 7% humic acid, 0.2% citric acid (weight ratio polysaccharide/clay: 25/75, cross-linking with citric acid, with addition of citric acid as auxiliary cross-linking element)

Chemical Solutions Employed, Description:

[UM]. 5% Humic acids solution: 100 ml distilled water+5 g humic acids (humic acids salts—Sigma Aldrich).

[CL]. 8% Clay suspension: 100 ml distilled water+8 gr. clay powder (common montmorillonite for enological uses).

[CMC]. 2.5% Carboxymethyl cellulose solution: 100 ml distilled water, +2.5 g CMC (CMC sodium salt—Sigma Aldrich).

[CA] Citric acid solution 0.1 M (21.0 gr/l) (citric acid monoidrate—Sigma aldrich).

Synthesis Description:

1. Mix the [UM] solution and [CL] suspension to obtain an organo-mineral suspension with a weight ratio humic acids/clay=0.10.

2. Mix the obtained suspension and [CMC] solution to prepare a suspension with a weight ratio CMC/clay=25/75_{w/w}.

3. Add [CA] to obtain an 1% citric acid/[CMC] fraction.

4. Thoroughly homogenise with magnetic stirring during 1 hour at T 50°.

5. Adjust pH to 4.1 with HCl solution.

6. Homogenise solution for 2 hours with magnetic stirring T 50° C. and check pH until this appear stable.

7. Dehydrate sample at room temperature.

8. Cook in oven at 85° C. for 6 hours.

9. Hydrate the cooked sample by submerging in distilled water at room temperature for 24 hours. The measured swelling degree is 29.

10. Dehydrate sample in acetone bath or by ventilation at room temperature and re-swelling in distilled water for 4 hours two times. The measured swelling degree is 53.

### Example 4

Preparation of a cross-linked organic-mineral polymer composite hydrogel with approximate composition: 42.9% montmorillonite clay, 42.9% natural polymer, 14.2% humic acid (weight ratio polysaccharide/clay: 50/50, cross-linking with humic acid only)

Chemical Solutions Employed, Description:

[UM]. 5% Humic acids solution: 100 ml distilled water+5 g humic acids (humic acids salts—Sigma Aldrich).

[CL]. 8% Clay suspension: 100 ml distilled water+8 gr. clay powder (common montmorillonite for enological uses).

[CMC]. 2.5% Carboxymethyl cellulose solution: 100 ml distilled water, +2.5 g CMC (CMC sodium salt—Sigma Aldrich).

Synthesis Description:

1. Mix the [UM] solution and [CL] suspension to obtain a organo-mineral suspension with a weight ratio humic acids/clay=0.33.

2. Mix the obtained suspension and [CMC] solution to prepare a suspension with a weight ratio CMC/clay=50/50_{w/w}.

3. Thoroughly homogenise with magnetic stirring during ½ hour at T 50°

4. Adjust pH to 4.75 with HCl solution.

5. Homogenise solution for 2 hours with magnetic stirring T 50° C. and check pH until this appear stable.

6. Dehydrate sample at room temperature

7. Cook in oven at 110° C. for 4 hours

8. Hydrate the cooked sample by submerging in distilled water at room temperature for 24 hours. The measured swelling degree is 23.

9. Dehydrate sample in acetone bath or by ventilation at room temperature and re-swelling in distilled water for 4 hours two times. The measured swelling degree is 45.

### Example 5

Preparation of a cross-linked organic-mineral polymer composite hydrogel with approximate composition: 48.8% montmorillonite clay, 48.8% natural polymer, 2.4% humic acid (weight ratio polysaccharide/clay: 50/50, cross-linking with humic acid only)

Chemical Solutions Employed, Description:

[UM]. 5% Humic acids solution: 100 ml distilled water+5 g humic acids (humic acids salts—Sigma Aldrich).

[CL]. 8% Clay suspension: 100 ml distilled water+8 gr. clay powder (common montmorillonite for enological uses).

[CMC]. 2.5% Carboxymethyl cellulose solution: 100 ml distilled water, +2.5 g CMC (CMC sodium salt—Sigma Aldrich).

Synthesis Description:

1. Mix the [UM] solution and [CL] suspension to obtain a organo-mineral suspension with a weight ratio humic acids/clay=0.05.

2. Mix the obtained suspension and [CMC] solution to prepare a suspension with a weight ratio CMC/clay=50/50_{w/w}.

3. Thoroughly homogenise with magnetic stirring during ½ hour at T 50°.

4. Adjust pH to 4.75 with HCl solution.

5. Homogenise solution for 2 hours with magnetic stirring T 50° C. and check pH until this appear stable.

6. Dehydrate sample at room temperature.

7. Cook in oven at 110° C. for 4 hours.

8. Hydrate the cooked sample by submerging in distilled water at room temperature for 24 hours. The measured swelling degree is 40.

9. Dehydrate sample in acetone bath or by ventilation at room temperature and re-swelling in distilled water for 4 hours two times. The measured swelling degree is 101.

### Example 6

Preparation of a cross-linked organic-mineral polymer composite hydrogel with approximate composition: 42.9% montmorillonite clay, 42.9% natural polymer, 14.2% humic acid (weight ratio polysaccharide/clay: 50/50, cross-linking with humic acid only)

Chemical Solutions Employed, Description:

[UM]. 5% Humic acids solution: 100 ml distilled water+5 g humic acids (humic acids salts—Sigma Aldrich).

[CL]. 8% Clay suspension: 100 ml distilled water+8 gr. clay powder (common montmorillonite for enological uses).

[CMC]. 2.5% Carboxymethyl cellulose solution: 100 ml distilled water, +2.5 g CMC (CMC sodium salt—Sigma Aldrich).

Synthesis Description:

1. Mix the [UM] solution and [CL] suspension to obtain a organo-mineral suspension with a weight ratio humic acids/clay=0.33;

2. Mix the obtained suspension and [CMC] solution to prepare a suspension with a weight ratio CMC/clay=50/50_{w/w}.

3. Thoroughly homogenise with magnetic stirring during ½ hour at T 50°.

4. Adjust pH to 4.75 with HCl solution.

5. Homogenise solution for 2 hours with magnetic stirring T 50° C. and check pH until this appear stable.

6. Dehydrate sample at room temperature.

7. Cook in oven at 150° C. for 6 hours.

8. Hydrate the cooked sample by submerging in distilled water at room temperature for 24 hours. The measured swelling degree is 6.

Results and Discussion:

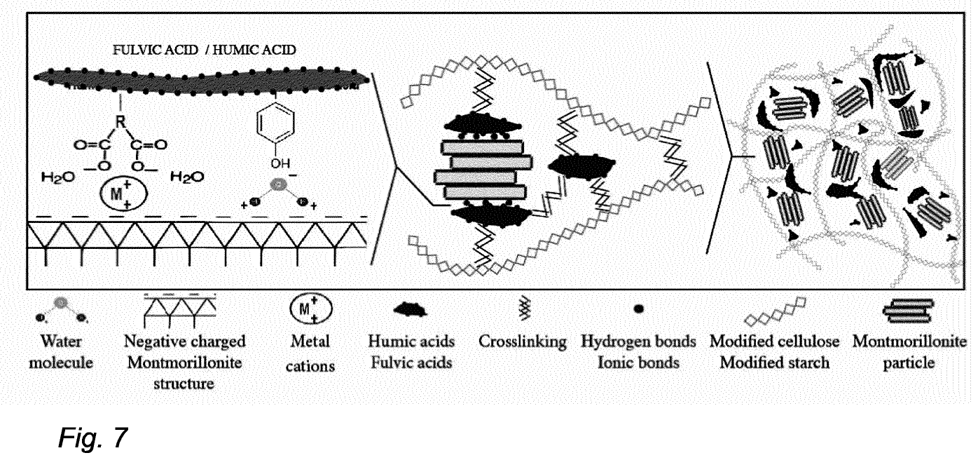

1. Examples 1 to 3 disclose the preparation of hydrogels wherein the polysaccharides are cross-linked by means of cross-linking agents formed by the organo-mineral complex and the polycarboxylic acid. A schematic representation of the hydrogel structure is shown in FIG. 7.

2. Examples 4 to 6 disclose the preparation of hydrogels wherein the polysaccharides are cross-linked by means of cross-linking agents formed by the organo-mineral complex only.

3. During the first swelling, some of the humic acids disperse into the solution (fraction that did not take part in the reaction), this release of humic acids in solution decreases drastically during subsequent re-swellings.

4. The sample dry weight tends to decrease after each dehydration/absorption cycle, whereas the absorption capacity increases.

5. The hydrogel displays uniform volume increase along the three dimensional axes during swelling therefore maintaining its original shape; in other words, the swelling of a thin slurry of dry hydrogel along a given dimensional axis, once immersed in water, will be proportional to its initial size along that axis, with a fast swelling rate (1 hour to reach full swelling).

6. The sample dry weight goes through several decreases during the synthesis procedure. The loss in dry matter weight is initially due to the moisture present in the polymer matrix (10 wt % ascertained), which is removed during cooking. After each subsequent swelling and dehydration cycle, the sample dry weight decreases further first due to the impurities released and soluble fractions or unreacted fraction which are partially extracted during each hydration phase. After that the loss in dry matter weight is due to the depolymerisation process or natural degradation of the hydrogel.

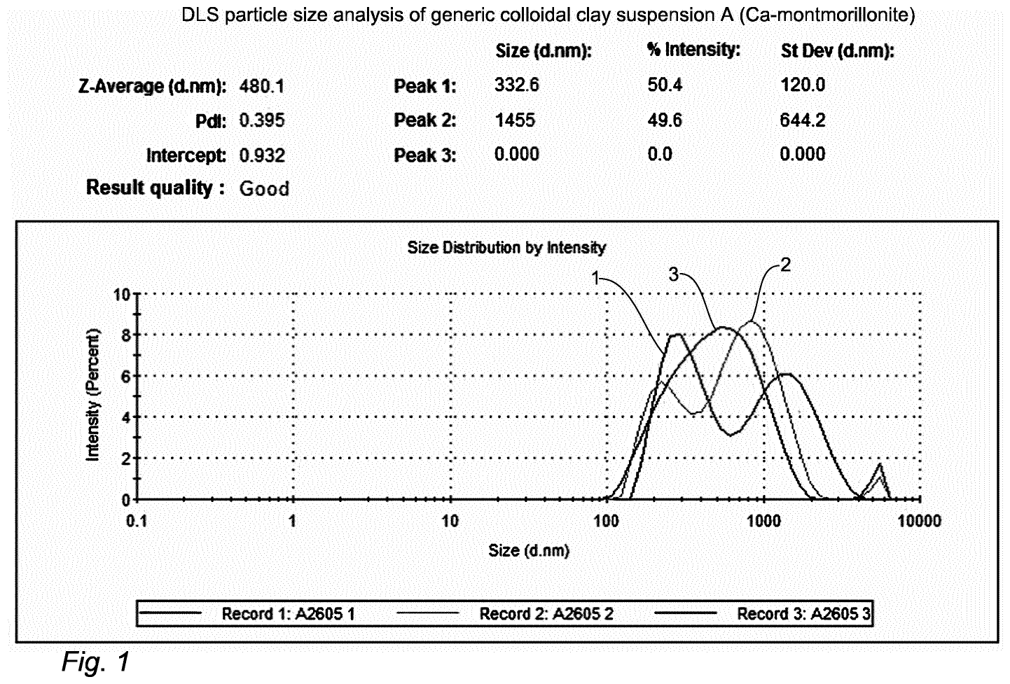

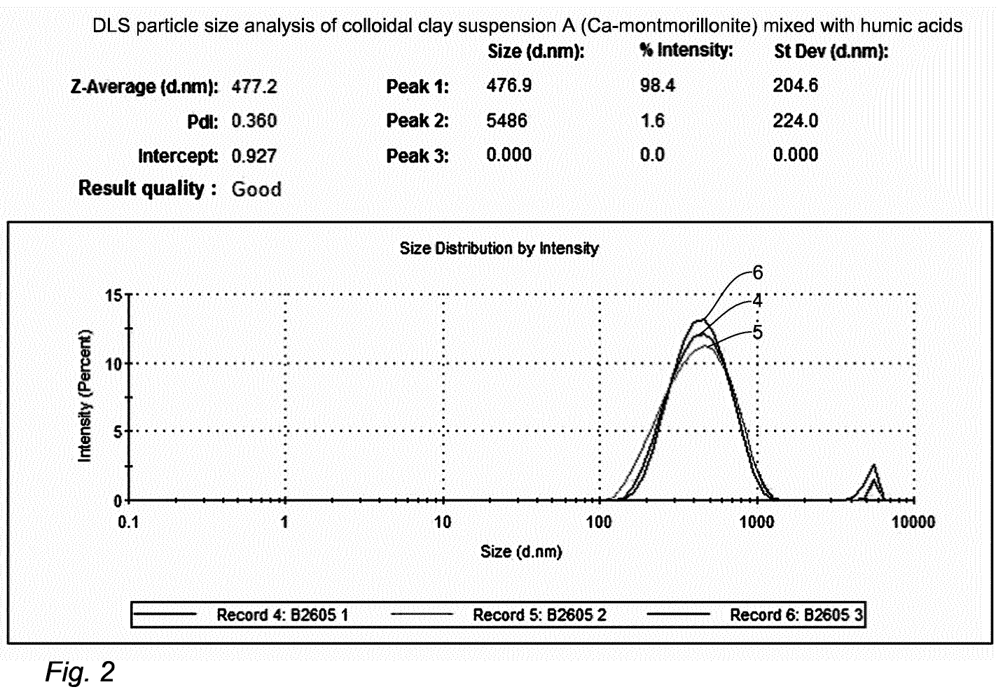

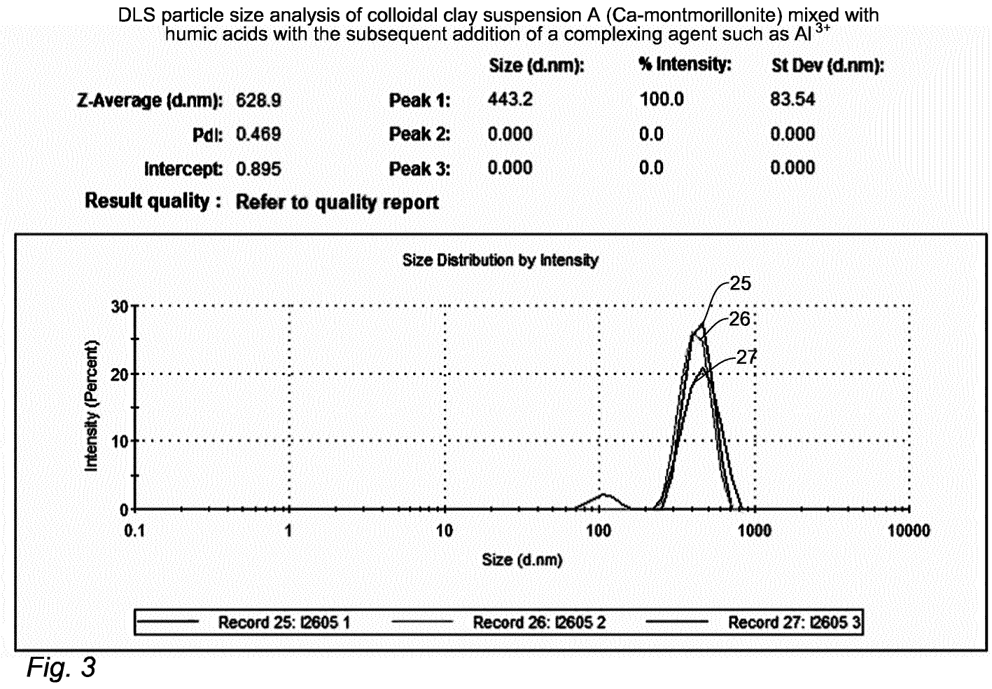

7. Comparing the DLS analysis performed on a suspension of humic acids and clay (FIG. 2), and a pure clay suspension (FIG. 1), it can be seen that the presence of humic acids makes possible to obtain a roughly monodimensional suspension, which results narrower compared to the one with only clay. The addition of complexing cations such as Ca²⁺, Fe³⁺, Al³⁺ can favour the formation of particles (complexes) with a relatively higher average hydrodynamic diameter, but displaying a lower standard deviation around the average (FIG. 3).

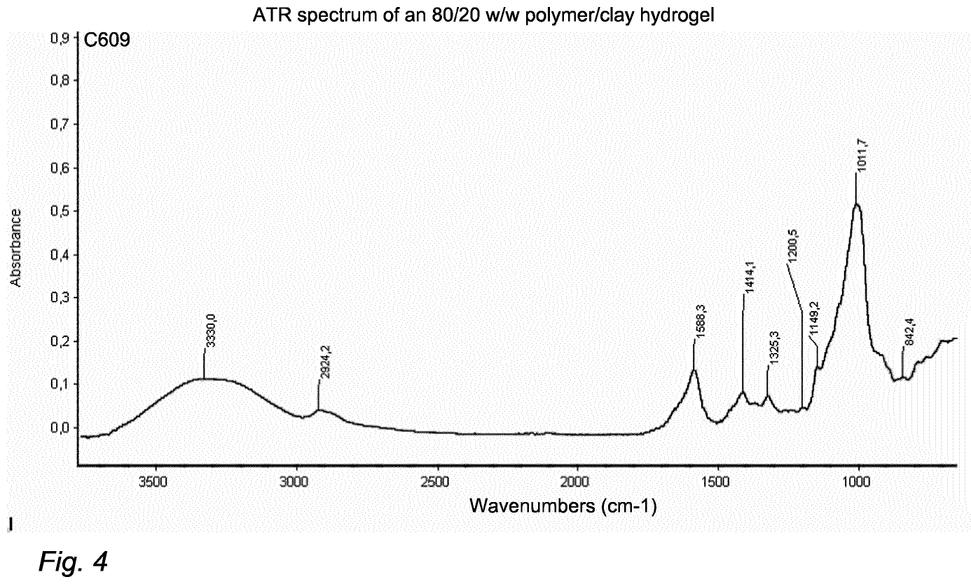

8. In FIG. 4 the typical ATR spectrum of the hydrogel of the invention consisting of humic acids, Ca-Montmorillonite, carboxymethylcellulose and waxy corn starch is shown.

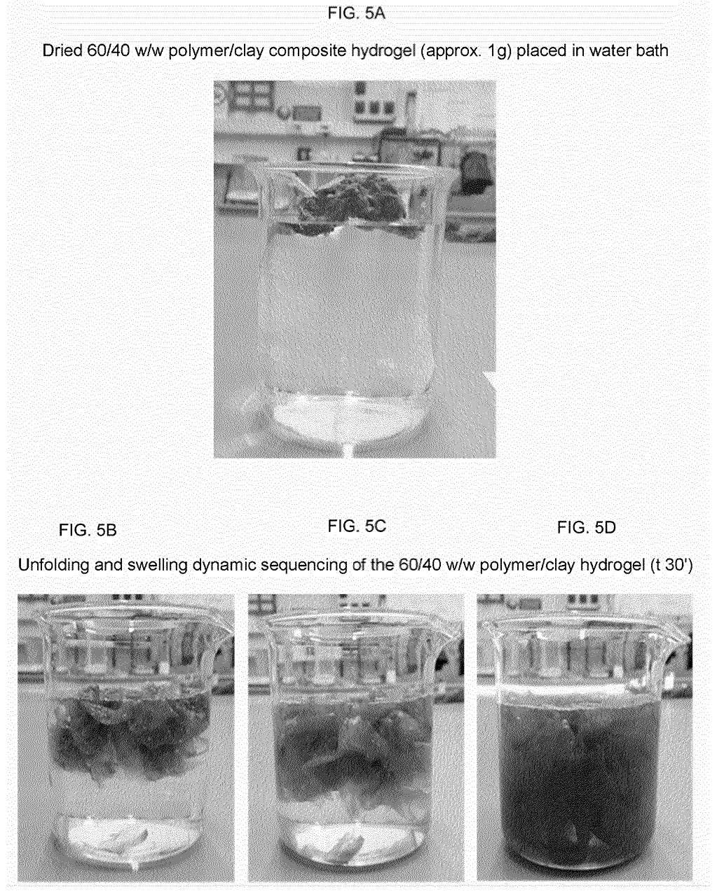

9. In FIG. 5a is shown a sample of the hydrogel prepared according to Example 2, as soon as immersed in water at room temperature. FIGS. 5b to 5d shows the same sample while unfolding and swelling in the water. FIG. 5d is the hydrogel after 30 minutes of immersion.

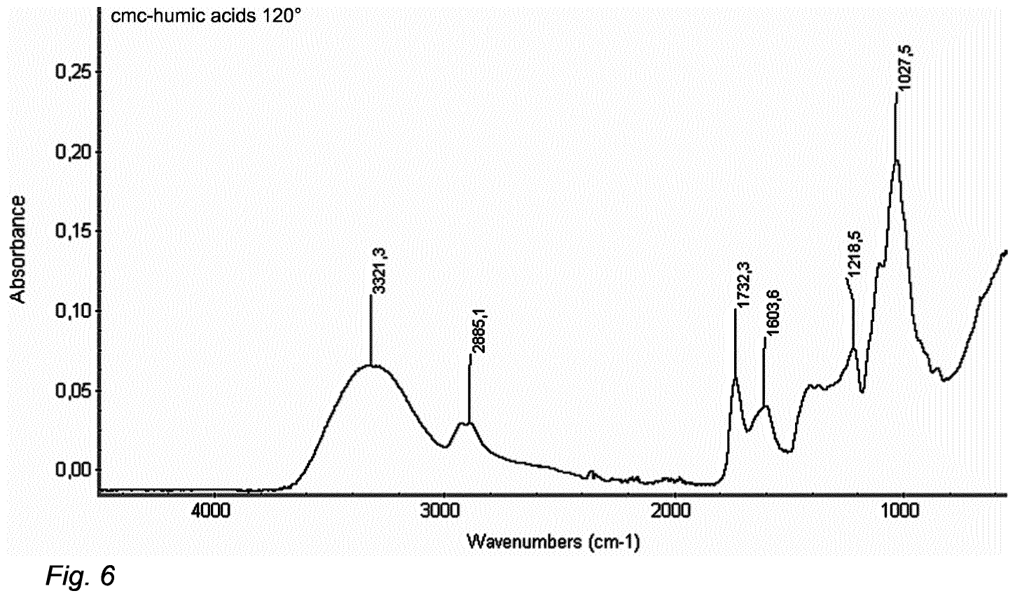

10. In a separate test, a mixture of polysaccharides and humic acids having the concentration of the hydrogel of the invention, has been prepared and subjected to reaction conditions used for the hydrogel. The mixture has been analysed before and after the reaction. In FIG. 6 is reported the ATR spectrum of the mixture after the reaction, wherein a significant peak at 1732 cm⁻¹, which is not present in the ATR spectrum of the mixture before reaction, may be noted. This peak corresponds to an carbonylic group belonging to an ester bond which proves that the esterification reaction between polysaccharides and humic acids took place.

1. A hydrogel comprising one or more hydrosoluble polysaccharides which are cross-linked by cross-linking agents, wherein said cross-linking agents form covalent bonds with said polysaccharides, and wherein said cross-linking agents comprise at least one of humic or fulvic acids.

2. The hydrogel according to claim 1, wherein said at least one of humic or fulvic acids are, at least in part, complexed to clay, so as to form an organo-mineral complex.

3. The hydrogel according to claim 2, wherein a weight ratio between said at least one of humic or fulvic acids and the clay is between 0.05 w/w to 2 w/w.

4. The hydrogel according to claim 1, wherein said at least one of: humic or fulvic acids form covalent bonds with said polysaccharides.

5. The hydrogel according to claim 1, wherein a weight ratio between said at least one of: humic or fulvic acids and said polysaccharides is between 0.02 w/w and 1 w/w.

6. The hydrogel according to claim 1, wherein said cross-linking agents comprise an auxiliary cross-linking element which is covalently bonded to both said at least one of: humic or fulvic acids and to said polysaccharides.

7. The hydrogel according to claim 6, wherein said auxiliary cross-linking element is a polycarboxylic acid.

8. The hydrogel according to claim 1, wherein the clay is selected from the group consisting of: smectites, attapulgite, vermiculite, allophane and mixture thereof.

9. The hydrogel according to claim 8, wherein the clay is Ca2+ Montmorillonite.

10. The hydrogel according to claim 1, wherein the polysaccharides are highly hydrophilic substituted polymers selected from the group consisting of: celluloses, dextrans and substituted dextrans, starches and substituted starches, natural gums, glycosaminoglycans, chitosan, alginates, pectins and mixtures thereof.

11. The hydrogel according to claim 1, wherein the polysaccharides are selected from the group consisting of: carboxymethyl celluloses, corn starches, potato starches and mixtures thereof.

12. A method for preparing a hydrogel according to claim 1, comprising the step of cross-linking one or more hydrosoluble polysaccharides by forming covalent bonds with a cross-linking agent, wherein the cross-linking agent comprises at least one of: humic or fulvic acids.

13. The method according to claim 12, wherein, before said cross-linking, said at least one of: humic or fulvic acids are contacted with clay, so as to form an organo-mineral complex.

14. The method according to claim 12, wherein said cross-linking is obtained by contacting said at least one of: humic or fulvic acids and said polysaccharides at a temperature and for a time suitable to form covalent bonds between said at least one of humic or fulvic acids and the polysaccharides.

15. The method according to claim 12, wherein said cross-linking is carried out at a temperature between 80° C. and 150° C.

16. The method according to claim 14, wherein said polysaccharides and said cross-linking agents are dehydrated before being heated to said temperature.

17. The method according to claim 12, wherein said cross-linking is obtained by contacting said at least one of: humic or fulvic acids and said polysaccharides in presence of a polycarboxylic acid.

18. Use of a hydrogel according to claim 1 as adsorbent material for manufacturing biodegradable diapers or as adsorbent material or carrier for environmentally dangerous molecule or substances of interest, or as coating for seeds or fertilizers in agriculture.
